(19) United States
(12) Patent Application Publication
(10) Pub. No.: US 2006/0078869 A1
(43) Pub. Date: Apr. 13, 2006

(54) Lesson plan organizer

(76) Inventor: Lana Jo Whicker, Danville, IN (US)

Correspondence Address: Bryan S. Redding;Cohen Garelick & Glazier, Suite 800, 8888 Keystone Crossing, Indianapolis, IN, 46240, US

(21) Appl. No.: 11/119,506

(22) Filed: Apr. 28, 2005

Related U.S. Application Data
(60) Provisional application No. 60/566,571, filed on Apr. 29, 2004.

(51) Int. Cl. G09B 25/00

(52) U.S. Cl. 434/365

(57) ABSTRACT

The present invention discloses a lesson plan organizer, whereby the individual lesson plans can be followed continuously, despite interruptions and lack of continuity, without the need for rewriting or retyping the entire plan, but still allowing flexibility when it comes to revisions or additions/subtractions to the plans.

### CROSS-REFERENCE TO RELATED APPLICATIONS

Applicant claims priority to application No. 60/566,571, filed Apr. 29, 2004.

### STATEMENT REGARDING FEDERAL SPONSORED RESEARCH OR DEVELOPMENT

Not Applicable

### REFERENCE TO SEQUENCE LISTING, ETC.

Not Applicable

### BACKGROUND

The present invention relates to an improved lesson plan organizer that is flexible and easy to use. More particularly, the present invention relates generally to a lesson plan organizer that can be used continuously independent of calendar date or subject matter, instead relying upon academic progress of the students.

Lesson plan books are already known. E.G. Rainbow's Lesson Plan Book, Teacher Created Materials, Inc.'s Lesson Plan and Record Book. However, these prior known devices are limited to a lesson plan, either for one subject or multiple subjects, that are written or typed in the lesson plan book and then associated with a certain day or date (i.e. Monday the 12^{th}). Problems arise when the lesson for certain subject for a certain day is not completed or even started. A teacher is then forced to flip back to a prior lesson on a date in the past or to rewrite or retype the entire lesson plan on the new date. This becomes even more confusing when multiple subjects are included in the lesson plan book because one subject may have proceeded as planned, while another has been delayed. This problem is then exacerbated when the teacher is absent and a substitute must then appear and attempt to follow the lesson plan for the absent teacher. Thus, there exists a significant demand for a device and method of using such that provides a flexible lesson plan organizer that is independent of date and subject matter restrictions and instead relies upon the academic progress of the class, without the need to rewrite, retype or revise such plans.

### BRIEF SUMMARY

The present invention is directed to the needs and desires noted above for a flexible lesson plan organizer that can adjust as necessary to schedule changes without the need to constantly update or rewrite the lesson plan. It is a further object of this invention to allow users to generate a flexible lesson plan that can include additions and subtractions without undue effort. Furthermore, it is an object of this invention that the device be such that anyone, including a substitute teacher, would be able to use the device of another teacher to provide continuity of education. It is another object of this invention that the device contain additional storage for miscellaneous needs.

These and other features, aspects and advantages of the present invention will become better understood with reference to the following description, appended claims and accompanying drawing.

### BRIEF DESCRIPTION OF THE DRAWINGS

FIG. 1: shows a schematic of one claimed embodiment.

### DESCRIPTION

The flexible lesson plan organizer of this invention may be produced by binding or securing multiple pages into any one of commonly known binding or securing devices, in the preferred embodiment an 8½ in.×11 in. ring-type binder, even though any size would accomplish the task. There is then a flap, or flaps attached to the front portion or left exterior edge, such that the flap, or flaps, can fold over a page or pages held in the binding or securing device to keep the selected page or pages separate from the other pages secured in the binding or securing device to the right of the selected page or pages. In this way page 1 can be separated from page 2 and the following pages, for an undetermined amount of time. In the preferred embodiment, the 8½ in.×11 in. pages are divided horizontally into three separate and equal sections, each section for a different subject, said sections being perforated or cut to allow independent movement of each section. In this way, a lesson contained in the top section can be sequentially accessed without the necessity of turning either of the other two sections. In this way, a lesson, once taught, is folded from the right to the lift side of the lesson plan organizer and then tucked under the separator, which in the preferred embodiment is a plastic separator, but any suitable separator would achieve the required goal of maintaining the position of each lesson that has already been taught. This allows the next lesson to be visible and accessible on the right side of the lesson plan organizer. In the preferred embodiment a second unit for another group of lessons, with another separator, is also disclosed.

The invention can be better understood with reference to the attached drawing, illustrating a representative and nonlimiting embodiment.

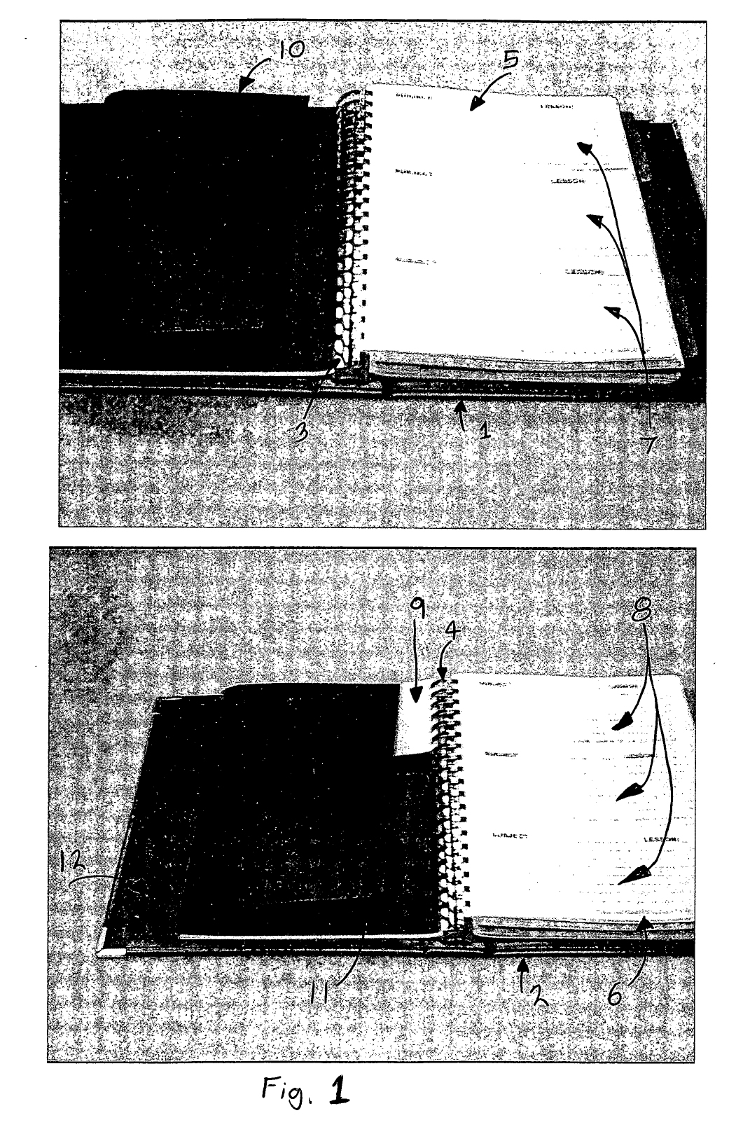

FIG. 1 shows the preferred embodiment of the lesson plan organizer, 1 & 2, as claimed herein. The binding or securing device, 3 & 4, consists of a ring-type binder that is commonly known in the art. A multitude of pages containing lessons, 5 & 6, are secured in the right-type binder. A user is free to write or type the lessons onto the spaces provided, 7 & 8. Once a lesson has been taught 9, it can then be flipped to the left and secured using the plastic separator, 10 & 11.

In the embodiment shown in FIG. 1, there is also contained at least one pocket, 12, to allow for additional storage.

Although the present invention has been described in considerable detail with reference to certain preferred versions thereof, other versions are possible. Therefore, the spirit and scope of the appended claims should not be limited to the description of the preferred versions contained herein.

What is claimed is:

1. A lesson plan organizer comprising:
a) a binding or securing device;
b) whereby the binding or securing device is suitable to hold multiple sheets of paper in an organized manner, said paper containing lesson plans;
c) a separator secured to the left side of the binding or securing device such that the left-most paper or first page in the binding or securing device can be flipped over or otherwise secured, thereby separating the lessons that have already been taught, and allowing the lessons on the following pages to be easily accessed and visible to the user.

2. The device of claim 1 whereby the binding or securing device is a ring-type binder.

3. The device of claim 1 whereby the binding or securing device is a metal ring-type binder.

4. The device of claim 1 whereby the binding or securing device is a plastic ring-type binder.

5. The device of claim 1 whereby the sheets contained in the binding or securing devices are separated into 2 horizontal sections to allow for multiple lessons on each page.

6. The device of claim 1 whereby the sheets contained in the binding or securing devices are separated into 3 horizontal sections to allow for multiple lessons on each page.

7. The device of claim 1 whereby the sheets contained in the binding or securing devices are separated into 4 horizontal sections to allow for multiple lessons on each page.

8. The device of claim 1 whereby the separator is a stiff plastic material connected to the center section of the binding or securing device extending outwardly and then turning back onto itself, creating a “j” shape.

9. The device of claim 1 whereby the lesson plan organizer is of suitable size to accept 8½ in.×11 in. paper into the binding or securing device.

10. A lesson plan organizer comprising:
a) a multiple page binding apparatus;
b) whereby the binding apparatus is suitable to hold multiple pages of paper in a sequential manner, said pages containing lesson plans, starting with the first lesson and ending with the last lesson;
c) a separator attached to the binding apparatus such that individual pages, containing lessons that have been taught, are stored or otherwise separated from the lessons that had yet to be taught, and allowing the lessons yet to be taught to be easily accessed and visible to the user.

11. The device of claim 10 whereby the multiple page binding apparatus is a ring-type binder.

12. The device of claim 10 whereby the multiple page binding apparatus a metal ring-type binder.

13. The device of claim 10 whereby the multiple page binding apparatus is a plastic ring-type binder.

14. The device of claim 10 whereby the pages of paper contained in the binding apparatus are separated into 2 horizontal sections to allow for multiple lessons on each page.

15. The device of claim 10 whereby the pages of paper contained in the binding apparatus are separated into 3 horizontal sections to allow for multiple lessons on each page.

16. The device of claim 10 whereby the pages of paper contained in the binding apparatus are separated into 4 horizontal sections to allow for multiple lessons on each page.

17. The device of claim 10 whereby the separator is a stiff plastic material.

18. The device of claim 10 whereby the separator is a stiff plastic material connected to the center section of the binding or securing device extending outwardly and then turning back onto itself, creating a “j” shape.

19. The device of claim 10 whereby the lesson plan organizer is of suitable size to accept 8½ in.×11 in. pages into the binding apparatus.
